(19) United States
(12) Patent Application Publication
(10) Pub. No.: US 2019/0252662 A1
(43) Pub. Date: Aug. 15, 2019

(54) NONAQUEOUS ELECTROLYTE SECONDARY BATTERY

(71) Applicant: Sumitomo Chemical Company, Limited, Tokyo (JP)

(72) Inventors: Eiko KASHIWAZAKI, Kasuga-shi (JP); Satoshi YONEYAMA, Niihama-shi (JP)

(21) Appl. No.: 16/270,763

(22) Filed: Feb. 8, 2019

(30) Foreign Application Priority Data
Feb. 9, 2018 (JP) 2018-022485

(51) Int. Cl. H01M 2/16; H01M 10/0567

(52) U.S. Cl. CPC H01M 2/1653; H01M 2/1686; H01M 2300/0025; H01M 2/162; H01M 10/0567

(57) ABSTRACT

A nonaqueous electrolyte secondary battery which can inhibit deterioration in charging capacity after high-rate discharge is provided. The nonaqueous electrolyte secondary battery includes (i) a nonaqueous electrolyte secondary battery separator including a polyolefin porous film whose peeling strength measured by a blocking test is not less than 0.2 N and puncture strength changes through the blocking test by not more than 15%, and (ii) a nonaqueous electrolyte containing a predetermined additive in an amount of not less than 0.5 ppm and not more than 300 ppm.

This Nonprovisional application claims priority under 35 U.S.C. § 119 on Patent Application No. 2018-022485 filed in Japan on Feb. 9, 2018, the entire contents of which is hereby incorporated by reference.

### TECHNICAL FIELD

The present invention relates to a nonaqueous electrolyte secondary battery.

### BACKGROUND ART

Nonaqueous electrolyte secondary batteries, particularly lithium-ion secondary batteries, have a high energy density, and are therefore in wide use as batteries for personal computers, mobile telephones, portable information terminals, and the like. Such nonaqueous electrolyte secondary batteries have recently been developed as (i) batteries for consumer appliances such as power tools and cleaners and (ii) on-vehicle batteries.

As a nonaqueous electrolyte secondary battery, for example, a nonaqueous electrolyte secondary battery is known which includes a porous film containing a polyolefin as a main component as disclosed in Patent Literature 1.

### CITATION LIST

### Patent Literature

Patent Literature 1: Japanese Patent Application Publication, Tokukaihei, No. 11-130900 (1999)

### SUMMARY OF INVENTION

### Technical Problem

In regard to the above described batteries, in particular, in regard to the batteries for consumer appliances (such as power tools and cleaners), on-vehicle batteries, and the like, it is sometimes necessary to carry out high-rate discharge (e.g., discharge at 5 C in a case of the battery for the consumer appliance, discharge at 10 C in the case of the on-vehicle battery).

Here, according to a nonaqueous electrolyte secondary battery including a separator for a nonaqueous electrolyte secondary battery (hereinafter referred to as a “nonaqueous electrolyte secondary battery separator”) which separator is constituted by a conventional porous film as disclosed in Patent Literature 1, there has been a problem that a charging capacity is deteriorated after the above described high-rate discharge.

An aspect of the present invention is accomplished in view of the problem, and its object is to provide a nonaqueous electrolyte secondary battery in which a deterioration in charging capacity after high-rate discharge is inhibited.

### Solution to Problem

The present invention encompasses an invention as described in the following [1] through [3].

[1] A nonaqueous electrolyte secondary battery including: a nonaqueous electrolyte secondary battery separator including a polyolefin porous film; and a nonaqueous electrolyte,

the polyolefin porous film having a peeling strength of not less than 0.2 N, the peeling strength being measured by a blocking test,

the polyolefin porous film having a puncture strength that changes through the blocking test by not more than 15%, and

the nonaqueous electrolyte containing an additive in an amount of not less than 0.5 ppm and not more than 300 ppm, the additive having an ionic conductance decreasing rate L of not less than 1.0% and not more than 6.0%, the ionic conductance decreasing rate L being represented by the following expression (A):

L=(LA−LB)/LA (A)

where: LA represents an ionic conductance (mS/cm) of a reference electrolyte obtained by dissolving LiPF₆ in a mixed solvent, containing ethylene carbonate, ethyl methyl carbonate, and diethyl carbonate at a volume ratio of 3:5:2, so that a concentration of the LiPF₆ becomes 1 mol/L;

LB represents an ionic conductance (mS/cm) of an electrolyte obtained by dissolving the additive in the reference electrolyte so that a concentration of the additive becomes 1.0% by weight; and

the blocking test is carried out by (i) sandwiching, by a jig having a size of 100 mm×100 mm, two polyolefin porous films each of which is the polyolefin porous film and has a size of 80 mm×80 mm, (ii) leaving the two polyolefin porous films to stand still under a load of 3.5 kg in an atmosphere at a temperature of 133° C.±1° C. for 30 minutes, (iii) then removing the load, (iv) cooling the two polyolefin porous films to a room temperature, (v) then cutting out a specimen having a size of 27 mm×80 mm from the two polyolefin porous films, and (vi) measuring a peeling strength of the specimen at 100 mm/min. [2] The nonaqueous electrolyte secondary battery described in [1] in which: the nonaqueous electrolyte secondary battery separator is a laminated separator in which a porous layer is disposed on one surface or both surfaces of the polyolefin porous film; and

the porous layer contains one or more resins selected from the group consisting of a polyolefin, a (meth)acrylate-based resin, a polyamide-based resin, a polyester-based resin, and a water-soluble polymer.

[3] The nonaqueous electrolyte secondary battery described in [2] in which the polyamide-based resin is an aramid resin.

### Advantageous Effects of Invention

The nonaqueous electrolyte secondary battery in accordance with an embodiment of the present invention can inhibit a deterioration in charging capacity after high-rate discharge.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. The present invention also encompasses, in its technical scope, any embodiment derived by combining technical means disclosed in differing embodiments. Note that a numerical expression “A to B” herein means “not less than A and not more than B” unless otherwise stated.

A nonaqueous electrolyte secondary battery in accordance with an embodiment of the present invention includes a nonaqueous electrolyte secondary battery separator (later described) and a nonaqueous electrolyte (later described). Members, each constituting the nonaqueous electrolyte secondary battery in accordance with an embodiment of the present invention will be described below in detail.

[Nonaqueous Electrolyte Secondary Battery Separator]

The nonaqueous electrolyte secondary battery separator in accordance with an embodiment of the present invention includes a polyolefin porous film. The polyolefin porous film has therein many pores, connected to one another, so that a gas and/or a liquid can pass through the polyolefin porous film from one side to the other side. Note, here, that the “polyolefin porous film” means a porous film which contains a polyolefin-based resin as a main component. Note that the phrase “contains a polyolefin-based resin as a main component” specifically means that a porous film contains a polyolefin-based resin at a proportion of not less than 50% by volume with respect to the whole of materials of which the porous film is made. The proportion is preferably not less than 90% by volume, more preferably not less than 95% by volume.

The nonaqueous electrolyte secondary battery separator in accordance with an embodiment of the present invention can be a separator that is made up of only the polyolefin porous film or can be a laminated separator that further includes a porous layer in addition to the polyolefin porous film. That is, the polyolefin porous film can solely serve as a nonaqueous electrolyte secondary battery separator and also can serve as a base material of a laminated separator that is a nonaqueous electrolyte secondary battery separator.

The polyolefin-based resin more preferably contains a high molecular weight component having a weight-average molecular weight of 3×10⁵ to 15×10⁶. In particular, the polyolefin-based resin more preferably contains a high molecular weight component having a weight-average molecular weight of not less than 1,000,000, because the nonaqueous electrolyte secondary battery separator including the polyolefin porous film has higher strength.

Examples of the polyolefin-based resin include, but are not particularly limited to, homopolymers (for example, polyethylene, polypropylene, and polybutene) and copolymers (for example, ethylene-propylene copolymer) each of which homopolymers and copolymers is a thermoplastic resin and is produced through polymerization of a monomer(s) such as ethylene, propylene, 1-butene, 4-methyl-1-pentene, and/or 1-hexene.

The polyolefin porous film can contain any one of these polyolefin-based resins solely or can alternatively contain two or more of these polyolefin-based resins. Of these polyolefin-based resins, the polyolefin porous film preferably contains polyethylene because the polyolefin porous film containing polyethylene makes it possible to prevent (shut down) a flow of an excessively large electric current at a lower temperature. In particular, the polyolefin porous film preferably contains high molecular weight polyethylene which contains ethylene as a main component. Note that the polyolefin porous film can contain a component other than polyolefin, provided that the component does not impair a function of the polyolefin porous film.

Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable. The polyethylene further preferably contains a high molecular weight component having a weight-average molecular weight of 5×10⁵ to 15×10⁶.

A film thickness of the polyolefin porous film is not particularly limited, but is preferably not more than 20 μm. The film thickness is more preferably not more than 16 μm, further preferably not more than 11 μm. The film thickness is preferably not less than 4 μm, more preferably not less than 5 μm, further preferably not less than 6 μm. That is, the film thickness is preferably not less than 4 μm and not more than 20 μm. The polyolefin porous film having a film thickness of not less than 4 μm makes it possible to sufficiently prevent an internal short circuit of the nonaqueous electrolyte secondary battery. On the other hand, the polyolefin porous film having a film thickness of not more than 20 μm makes it possible to prevent an increase in size of the nonaqueous electrolyte secondary battery.

A weight per unit area of the polyolefin porous film is typically 4 g/m² to 20 g/m², preferably 4 g/m² to 12 g/m², more preferably 5 g/m² to 10 g/m². In a case where the weight per unit area is 4 g/m² to 20 g/m², it is possible to heighten weight energy density and volume energy density of the battery.

The polyolefin porous film has an air permeability of typically 30 sec/100 mL to 500 sec/100 mL, and preferably 50 sec/100 mL to 300 sec/100 mL, in terms of Gurley values. In a case where the air permeability is 30 sec/100 mL to 500 sec/100 mL, the polyolefin porous film exhibits sufficient ion permeability.

The polyolefin porous film has a porosity of preferably 20% by volume to 80% by volume, and more preferably 30% by volume to 75% by volume. In a case where the porosity is 20% by volume to 80% by volume, it is possible to (i) retain an electrolyte in a larger amount and (ii) obtain a function of more absolutely preventing (shutting down) a flow of an excessively large electric current.

Pores in the polyolefin porous film each have a pore diameter of preferably not more than 0.3 μm, and more preferably not more than 0.14 μm. In a case where the pore diameter of the pores is not more than 0.3 μm, it is possible to achieve sufficient ion permeability and to prevent particles constituting an electrode from entering the pores in the polyolefin porous film.

[Blocking Test, Peeling Strength, Puncture Strength Change Ratio]

The polyolefin porous film in accordance with an embodiment of the present invention has peeling strength of not less than 0.2 N, preferably not less than 0.3 N, more preferably not less than 0.35 N. Here, the peeling strength is a value measured by a blocking test carried out in conformity to JIS K6404-14. The peeling strength is typically not more than 2 N, and can be not more than 1 N. Here, the blocking test is carried out by (i) sandwiching, by a jig having a size of 100 mm×100 mm, two polyolefin porous films each of which has a size of 80 mm×80 mm, (ii) leaving the two polyolefin porous films to stand still under a load of 3.5 kg in an atmosphere at a temperature of 133° C.±1° C. for 30 minutes, (iii) then removing the load, (iv) cooling the two polyolefin porous films to a room temperature, (v) then measuring a peeling strength by Autograph at 100 mm/min.

The peeling strength is measured with use of a so-called T-peel test in which (i) end parts of two polyolefin porous films one of which is stacked on the other without using a supporting substrate or the like are sandwiched by respective jigs (chucks), (ii) the two polyolefin porous films are pulled in mutually opposite directions at 90° with respect to respective surfaces of the polyolefin porous films which have not been peeled, and (iii) thus the peeling strength is measured.

The T-peel test is carried out by a method that conforms to JIS K 6854-3. Specifically, the polyolefin porous films which have been cooled to a room temperature are cut out in a size of 27 mm×80 mm, and thus a specimen is prepared. Then, shorter sides of the two polyolefin porous films constituting the specimen are entirely sandwiched by respective chucks of the device, the two polyolefin porous films are peeled in a long-axis direction by pulling the shorter sides in mutually opposite directions, and a peeling strength at that time is measured.

Note that, in general, a peeling strength after peeling has started increases with time immediately after the start of peeling, and then the peeling strength becomes substantially constant (i.e., equalized) until immediately before the end of peeling. Here, a measured value of the peeling strength is an average value of peeling strength during a period from when the peeling strength becomes substantially constant after the start of peeling to when the peeling ends.

The peeling strength that is measured by the blocking test relates to denseness of a pore structure in the polyolefin porous film. Specifically, the peeling strength is heightened as the denseness increases. Therefore, in a case where the peeling strength measured by the blocking test is not less than 0.2 N, this means that the pore structure in the polyolefin porous film is dense.

The polyolefin porous film in accordance with an embodiment of the present invention has (i) the peeling strength of not less than 0.2 N which is measured by the blocking test and (ii) high denseness. Therefore, the polyolefin porous film in accordance with an embodiment of the present invention has high uniformity in the surface direction. From this, in the nonaqueous electrolyte secondary battery in accordance with an embodiment of the present invention, it is possible to inhibit a capacity from becoming nonuniform in an electrode surface direction due to high-rate discharge, and thus nonuniformity in the surface direction in recharging after the high-rate discharge can be corrected. As a result, it seems to be possible to inhibit a deterioration in charging capacity after high-rate discharge of the nonaqueous electrolyte secondary battery in accordance with an embodiment of the present invention.

The polyolefin porous film has a puncture strength that changes through the blocking test by not more than 15%, preferably by not more than 10%, more preferably by not more than 5%. The puncture strength change ratio is typically not less than 0.1% and can be not less than 1%. Here, the puncture strength is measured based on a maximum stress (gf) applied when the polyolefin porous film is punctured at 200 mm/min with a pin having a diameter of 1 mm and a tip having 0.5 R. The puncture strength change ratio is an absolute value of a ratio of change in puncture strength between before and after the blocking test, and is represented by 100×|(puncture strength after blocking test)−(puncture strength before blocking test)|/(puncture strength before blocking test).

The puncture strength change ratio is proportional to an amount of change in film shape between before and after the blocking test. The amount of change in film shape by a load in the blocking test relates to strength of a structure constituting meshes of the polyolefin porous film. As the puncture strength change ratio is smaller, the strength of the structure constituting the meshes is higher.

In a case where the puncture strength changes through the blocking test by not more than 15%, it is possible to inhibit deformation of the polyolefin porous film and nonuniformity in the electrode surface direction which would be caused by high-rate discharge. As a result, it is possible to inhibit a deterioration in charging capacity after high-rate discharge of the nonaqueous electrolyte secondary battery in accordance with an embodiment of the present invention.

Note that the separator has a puncture strength of preferably not less than 2 N, more preferably not less than 3 N. If the puncture strength is excessively low, then it may cause the separator to be punctured by positive electrode active material particles and negative electrode active material particles in a case where, for example, (i) an operation of laminating and winding a positive electrode, a negative electrode, and the separator is carried out during a battery assembling process, (ii) an operation of pressing and tightening rolls is carried out during a battery assembling process, or (iii) the battery is pressured from outside. This may cause a short circuit between the positive electrode and the negative electrode.

Pressure that is applied to the polyolefin porous film when the nonaqueous electrolyte secondary battery in accordance with an embodiment of the present invention is assembled is typically so small as to hardly influence an internal structure of the polyolefin porous film. Therefore, the internal structure (such as denseness of the pore structure and strength of the structure constituting the meshes) of the polyolefin porous film does not change through the assembly of the nonaqueous electrolyte secondary battery in accordance with an embodiment of the present invention. From this, the “peeling strength” and the “puncture strength change ratio” of the polyolefin porous film before assembling the nonaqueous electrolyte secondary battery in accordance with an embodiment of the present invention are respectively substantially identical with the “peeling strength” and the “puncture strength change ratio” of the polyolefin porous film provided inside the nonaqueous electrolyte secondary battery (i.e., the polyolefin porous film immediately after the assembly).

[Method for Producing Polyolefin Porous Film]

A method for producing the polyolefin porous film is not particularly limited. For example, a polyolefin porous film can be produced by stretching a sheet which has been prepared by (i) forming a film by adding a pore forming agent (such as calcium carbonate or plasticizer) to a thermoplastic resin and then (ii) removing the pore forming agent with use of an appropriate solvent. Here, by adjusting a heat fixation temperature in the stretching, it is possible to produce a polyolefin porous film which has (i) a peeling strength of not less than 0.2 N that is measured by the blocking test and (ii) a puncture strength that changes through the blocking test by not more than 15%. Specifically, by increasing the heat fixation temperature, it is possible to heighten the peeling strength that is measured by the blocking test and it is also possible to lower the puncture strength change ratio. Note that the heat fixation temperature in the stretching is set as appropriate depending on a resin material that constitutes the polyolefin porous film.

Specifically, for example, in a case where a polyolefin porous film is constituted by a polyolefin resin containing (i) ultra-high molecular weight polyethylene and (ii) a low molecular weight polyolefin having a weight-average molecular weight of not more than 10,000, it is preferable to produce the polyolefin porous film by a method including processes as described below:

(1) Obtaining a polyolefin resin composition by kneading 100 parts by weight of the ultra-high molecular weight polyethylene, 5 parts by weight to 200 parts by weight of the low molecular weight polyolefin having a weight-average molecular weight of not more than 10,000, and 100 parts by weight to 400 parts by weight of a pore forming agent such as calcium carbonate;
(2) Forming a sheet with use of the polyolefin resin composition;
(3) Removing the pore forming agent from the sheet obtained in the step (2); and
(4) Obtaining the polyolefin porous film by stretching the sheet obtained in the step (3).

[Porous Layer]

The porous layer preferably has an electrically insulating property. The porous layer is typically a resin layer containing a resin. The porous layer is preferably a heat-resistant layer or an adhesive layer. It is preferable that the resin of which the porous layer is made be insoluble in the electrolyte of the battery and be electrochemically stable when the battery is in normal use.

The porous layer is disposed on one surface or each of both surfaces of the polyolefin porous film, as necessary, so as to constitute the laminated separator. In a case where the porous layer is disposed on merely one surface of the polyolefin porous film, the porous layer is preferably disposed on that surface of the polyolefin porous film which surface faces the positive electrode, more preferably on that surface of the polyolefin porous film which surface comes into contact with the positive electrode, in the nonaqueous electrolyte secondary battery in accordance with an embodiment of the present invention.

Examples of the resin constituting the porous layer include polyolefins; (meth)acrylate-based resins; fluorine-containing resins; polyamide-based resins; polyimide-based resins; polyester-based resins; rubbers; resins each having a melting point or a glass transition temperature of not lower than 180° C.; water-soluble polymers; polycarbonate, polyacetal, and polyether ether ketone.

Of the above resins, polyolefins, polyester-based resins, (meth)acrylate-based resins, fluorine-containing resins, polyamide-based resins, and water-soluble polymers are preferable. As the polyamide resins, aramid resins such as aromatic polyamides and wholly aromatic polyamides are preferable. The polyester-based resins are preferably aromatic polyesters such as polyarylates, and liquid crystal polyesters.

The polyolefins are preferably polyethylene, polypropylene, polybutene, an ethylene-propylene copolymer, and the like.

Examples of the fluorine-containing resins encompass polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

Specific examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among those aramid resins, poly(paraphenylene terephthalamide) is more preferable.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Each of these resins contained in the porous layer can be used solely. Alternatively, two or more of these resins contained in the porous layer can be used in combination.

The porous layer can contain fine particles. The term “fine particles” herein means organic fine particles or inorganic fine particles, generally referred to as a filler. Therefore, in a case where the porous layer contains fine particles, the above-described resin contained in the porous layer functions as a binder resin which binds (i) the fine particles together and (ii) the fine particles and the porous film together. The fine particles are preferably insulating fine particles.

Examples of the organic fine particles contained in the porous layer include resin fine particles.

Specific examples of the inorganic fine particles contained in the porous layer include fillers each made of an inorganic matter such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. These inorganic fine particles are insulating fine particles. Of these fine particles, the porous layer can contain only one kind of fine particles or can alternatively contain two or more kinds of fine particles in combination.

Of the above fine particles, fine particles made of an inorganic matter are suitable. More preferable are fine particles made of an inorganic oxide such as silica, calcium oxide, magnesium oxide, titanium oxide, alumina, mica, zeolite, aluminum hydroxide, or boehmite. Still more preferable are fine particles made of at least one kind selected from the group consisting of silica, magnesium oxide, titanium oxide, aluminum hydroxide, boehmite, and alumina. Particularly preferable are fine particles made of alumina.

The porous layer contains the fine particles in an amount of preferably 1% by volume to 99% by volume, and more preferably 5% by volume to 95% by volume, with respect to 100% by volume of the porous layer. In a case where the amount of the fine particles falls within the above range, it is less likely that a void, which is formed when the fine particles come into contact with each other, is blocked by the resin or the like. This allows the porous layer to achieve sufficient ion permeability and an appropriate weight per unit area.

The porous layer can contain two or more kinds of fine particles in combination which two or more kinds differ from each other in particle size or specific surface area.

The porous layer has a thickness of preferably 0.5 μm to 15 μm (per layer), and more preferably 2 μm to 10 μm (per layer). In a case where the thickness of the porous layer is less than 0.5 μm (per layer), it may not be possible to sufficiently prevent an internal short circuit caused by breakage or the like of the nonaqueous electrolyte secondary battery. In addition, an amount of the electrolyte retained by the porous layer may be decreased. In contrast, in a case where the thickness of the porous layer is more than 15 μm (per layer), the battery characteristic may be deteriorated.

The porous layer has a weight per unit area of preferably 1 g/m² to 20 g/m² (per layer), and more preferably 4 g/m² to 10 g/m² (per layer).

A volume of a porous layer constituent component per square meter of the porous layer is preferably 0.5 cm³ to 20 cm³ (per layer), more preferably 1 cm³ to 10 cm³ (per layer), and still more preferably 2 cm³ to 7 cm³ (per layer).

The porous layer has a porosity of preferably 20% by volume to 90% by volume, and more preferably 30% by volume to 80% by volume so that the porous layer can achieve sufficient ion permeability. Pores in the porous layer each have a pore diameter of preferably not more than 3 μm, and more preferably not more than 1 μm, in view of prevention of entry of particles, constituting an electrode, into the pores in the porous layer.

[Laminated Separator]

A laminated separator (hereinafter also referred to as “laminated body”) in accordance with an embodiment of the present invention includes the polyolefin porous film and the porous layer. Preferably, the laminated separator has a configuration in which the porous layer is disposed on one surface or both surfaces of the polyolefin porous film.

The laminated body in accordance with an embodiment of the present invention has a film thickness of preferably 5.5 μm to 45 μm, and more preferably 6 μm to 25 μm.

The laminated body in accordance with an embodiment of the present invention has an air permeability of preferably 30 sec/100 mL to 1000 sec/100 mL, and more preferably 50 sec/100 mL to 800 sec/100 mL, in terms of Gurley values.

Note that the physical properties (such as the peeling strength measured by the blocking test, the puncture strength before the blocking test, and the puncture strength after the blocking test) of the polyolefin porous film included in the laminated separator can be measured by peeling (i.e., removing) the porous layer from the laminated separator.

The laminated separator in accordance with an embodiment of the present invention can include, in addition to the polyolefin porous film and the porous layer, publicly known layers (e.g., porous layer) such as a heat-resistant layer, an adhesive layer, and a protective layer as necessary, provided that the publicly known layers do not prevent the object of the present invention from being attained.

[Method for Producing Porous Layer and Method for Producing Laminated Body]

The porous layer and the laminated body in accordance with an embodiment of the present invention can be produced by, for example, a method in which (i) a coating solution (later described) is applied to a surface of the polyolefin porous film and then (ii) the coating solution is dried so that the porous layer is deposited.

Note that, before the coating solution is applied to the surface of the polyolefin porous film, the surface to which the coating solution is to be applied can be subjected to a hydrophilization treatment as necessary.

The coating solution used in a method for producing the porous layer and the laminated body in accordance with an embodiment of the present invention can be prepared typically by (i) dissolving, in a solvent, the resin that can be contained in the porous layer and (ii) dispersing, in the solvent, the fine particles that can be contained in the porous layer. Note, here, that the solvent in which the resin is to be dissolved also serves as a dispersion medium in which the fine particles are to be dispersed. Note, here, that the resin can be alternatively contained as an emulsion, instead of being dissolved in the solvent.

The solvent (dispersion medium) preferably (i) does not have an adverse effect on the polyolefin porous film, (ii) allows the resin to be uniformly and stably dissolved in the solvent, and (iii) allows the fine particles to be uniformly and stably dispersed in the solvent. Specific examples of the solvent (dispersion medium) include water and organic solvents. Each of these solvents can be used solely. Alternatively, two or more of these solvents can be used in combination.

The coating solution can be formed by any method, provided that it is possible for the coating solution to meet conditions (such as a resin solid content (resin concentration) and a fine particle amount) which are necessary to obtain a desired porous layer. Specific examples of a method for forming the coating solution include a mechanical stirring method, an ultrasonic dispersion method, a high-pressure dispersion method, and a media dispersion method. Note that the coating solution can contain, as a component other than the resin and the fine particles, an additive such as a disperser, a plasticizer, a surfactant, and a pH adjustor, provided that the additive does not prevent the object of the present invention from being attained. Note that the additive can be contained in an amount that does not prevent the object of the present invention from being attained.

A method for applying the coating solution to the polyolefin porous film, that is, a method for forming the porous layer on the surface of the polyolefin porous film is not limited to any particular one. Examples of the method for forming the porous layer include: a method in which the coating solution is applied directly to the surface of the polyolefin porous film and then the solvent (dispersion medium) is removed; a method in which (i) the coating solution is applied to an appropriate support, (ii) the solvent (dispersion medium) is removed so that the porous layer is formed, (iii) the porous layer is pressure-bonded to the polyolefin porous film, and then (iv) the support is peeled off; and a method in which (i) the coating solution is applied to an appropriate support, (ii) the polyolefin porous film is pressure-bonded to a surface of the support to which surface the coating solution is applied, (iii) the support is peeled off, and then (iv) the solvent (dispersion medium) is removed.

The coating solution can be applied to the polyolefin porous film or the support by a conventionally publicly known method. Specific examples of such a method include a gravure coater method, a dip coater method, a bar coater method, and a die coater method.

The solvent (dispersion medium) is generally removed by drying the coating solution. Note that the coating solution can be dried after the solvent (dispersion medium) contained in the coating solution is replaced with another solvent.

[Positive Electrode]

The positive electrode included in the nonaqueous electrolyte secondary battery in accordance with an embodiment of the present invention is not limited to any particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binder resin (binding agent), is formed on a current collector. The active material layer can further contain an electrically conductive agent.

Examples of the positive electrode active material include materials each capable of being doped with and dedoped of metal ions such as lithium ions or sodium ions. Specific examples of the materials include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. The active material layer can contain (i) only one kind of electrically conductive agent or (ii) two or more kinds of electrically conductive agents in combination.

Examples of the binding agent include: fluorine-based resins such as polyvinylidene fluoride (PVDF); acrylic resin; and styrene butadiene rubber. Note that the binding agent serves also as a thickener.

Examples of the current collector included in the positive electrode (i.e., positive electrode current collector) include electric conductors such as Al, Ni, and stainless steel. Of these electric conductors, Al is more preferable because Al is easily processed into a thin film and is inexpensive.

Examples of a method for producing the positive electrode sheet include: a method in which the positive electrode active material, the electrically conductive agent, and the binding agent are pressure-molded on the positive electrode current collector; and a method in which (i) the positive electrode active material, the electrically conductive agent, and the binding agent are formed into a paste with use of an appropriate organic solvent, (ii) the positive electrode current collector is coated with the paste, and (iii) the paste is dried and then pressured so that the paste is firmly fixed to the positive electrode current collector.

[Negative Electrode]

A negative electrode included in the nonaqueous electrolyte secondary battery in accordance with an embodiment of the present invention is not limited to any particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binder resin, is formed on a current collector. The active material layer can further contain an electrically conductive agent.

Examples of the negative electrode active material include materials each capable of being doped with and dedoped of metal ions such as lithium ions or sodium ions. Examples of the materials include carbonaceous materials. Examples of the carbonaceous materials include natural graphite, artificial graphite, cokes, carbon black, and pyrolytic carbons.

Examples of the current collector included in the negative electrode (i.e., negative electrode current collector) include Cu, Ni, stainless steel, and the like. Of these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressured so that the paste is firmly fixed to the negative electrode current collector. The paste preferably contains an electrically conductive agent as described above and a binding agent as described above.

[Nonaqueous Electrolyte]

The nonaqueous electrolyte in accordance with an embodiment of the present invention contains an additive in an amount of 0.5 ppm to 300 ppm, the additive having an ionic conductance decreasing rate L of not less than 1.0% and not more than 6.0%, the ionic conductance decreasing rate L being represented by the following expression (A):

L=(LA−LB)/LA (A)

where: LA represents an ionic conductance (mS/cm) of a reference electrolyte obtained by dissolving LiPF₆ in a mixed solvent, containing ethylene carbonate, ethyl methyl carbonate, and diethyl carbonate at a volume ratio of 3:5:2, so that a concentration of the LiPF₆ becomes 1 mol/L; and LB represents an ionic conductance (mS/cm) of an electrolyte obtained by dissolving the additive in the reference electrolyte so that a concentration of the additive becomes 1.0% by weight.

The additive is not limited to any particular one, provided that the additive is a compound which meets the above condition (i.e., the ionic conductance decreasing rate L represented by the expression (A) is not less than 1.0% and not more than 6.0%). Specific examples of the compound which meets the above condition include pentaerythritol tetrakis[3-(3,5-di-tert-butyl-4-hydroxyphenyl)propionate], triethyl phosphate, vinylene carbonate, propanesultone, 2,6-di-tert-butyl-4-methyl phenol, 6-[3-(3-t-Butyl-4-hydroxy-5-methylphenyl)propoxy]-2,4,8,10-tetra-t-butyldibenzo[d,f][1,3,2]dioxaphosphepin, tris(2,4-di-tert-butylphenyl)phosphite, 2-[1-(2-Hydroxy-3,5-di-tert-pentylphenyl)ethyl]-4,6-di-tert-pentylphenyl acrylate, and dibutylhydroxytoluene.

The nonaqueous electrolyte in accordance with an embodiment of the present invention contains an electrolyte substance and an organic solvent, as with the case of a nonaqueous electrolyte generally used in a nonaqueous electrolyte secondary battery. Examples of the electrolyte substance include metal salts such as a lithium salt (e.g., LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄). Each of these electrolyte substances can be used solely. Alternatively, two or more of these electrolyte substances can be used in combination.

Examples of the organic solvent contained in the nonaqueous electrolyte include aprotic polar solvents such as carbonates, ethers, esters, nitriles, amides, carbamates, sulfur-containing compounds, and fluorine-containing organic solvents each obtained by introducing a fluorine group into any of these organic solvents. Each of these organic solvents can be used solely. Alternatively, two or more of these organic solvents can be used in combination.

The organic solvent is preferably a mixed solvent containing a ring compound (such as ethylene carbonate) and a chain compound (such as ethyl methyl carbonate and diethyl carbonate) as with the case of the reference electrolyte. The mixed solvent contains the ring compound and the chain compound at a volume ratio of preferably 2:8 to 4:6, more preferably 2:8 to 3:7, and particularly preferably 3:7. Note that the mixed solvent in which the ring compound and the chain compound are mixed at a volume ratio of 3:7 is an organic solvent particularly generally used for a nonaqueous electrolyte of a nonaqueous electrolyte secondary battery.

The additive in accordance with an embodiment of the present invention causes a decrease in the ionic conductance of the reference electrolyte.

A reason why the deterioration in charging capacity after high-rate discharge can be inhibited by adding the additive in accordance with an embodiment of the present invention to the nonaqueous electrolyte can be, for example, the following reason: By adding the additive, a degree of dissociation of ions in the nonaqueous electrolyte may decrease. This can suppress non-existence of ions in the interface between the separator and the electrode when the battery is charged or discharged, in particular, when the battery operates at a high speed. This may make it possible to inhibit a deterioration in charging capacity after high-rate discharge.

In view of suppression of non-existence of the ions in a vicinity of the electrode, the nonaqueous electrolyte contains the additive in an amount of not less than 0.5 ppm, preferably not less than 20 ppm, more preferably not less than 45 ppm.

Meanwhile, in a case where the nonaqueous electrolyte contains the additive in an excessively large amount, not only the non-existence of the ions in the vicinity of the electrode is suppressed, but also a degree of dissociation of the ions in the entire nonaqueous electrolyte is excessively decreased. This prevents a flow of the ions in the entire nonaqueous electrolyte secondary battery, and rather causes a deterioration of the battery characteristic such as a charging capacity after high-rate discharge.

In view of inhibiting blockage of the flow of the ions in the entire nonaqueous electrolyte secondary battery, the nonaqueous electrolyte contains the additive in an amount of not more than 300 ppm, preferably not more than 250 ppm, and more preferably not more than 180 ppm.

Note, here, that, according to the nonaqueous electrolyte secondary battery in accordance with an embodiment of the present invention, which includes the nonaqueous electrolyte containing the additive in an amount of not less than 0.5 ppm and not more than 300 ppm, the degree of dissociation of the ions in the vicinity of the electrode (positive electrode) in a case where the nonaqueous electrolyte secondary battery is repeatedly charged and discharged, particularly, in a case where the nonaqueous electrolyte secondary battery is operated at a high speed is strongly affected by the amount of the additive in the vicinity of the electrolyte substance.

Therefore, according to the nonaqueous electrolyte secondary battery in accordance with an embodiment of the present invention, it is possible to suitably decrease the degree of dissociation of the ions in the vicinity of the electrode (positive electrode), regardless of a kind of the nonaqueous electrolyte. In other words, by the nonaqueous electrolyte containing the additive in an amount of not less than 0.5 ppm and not more than 300 ppm, it is possible to suitably decrease the degree of dissociation of the ions in the vicinity of the electrode (positive electrode), regardless of a kind and an amount of the electrolyte substance contained in the nonaqueous electrolyte and a kind of the organic solvent contained in the nonaqueous electrolyte. As a result, it is possible to inhibit a deterioration in charging capacity after high-rate discharge.

That is, it is possible to sufficiently inhibit a deterioration in charging capacity after high-rate discharge of the nonaqueous electrolyte secondary battery by adjusting (i) the “peeling strength measured by the blocking test” and the “ratio of change in puncture strength after the blocking test with respect to the puncture strength before the blocking test” of the nonaqueous electrolyte secondary battery separator to fall within respective suitable ranges as described above and (ii) the ionic conductance decreasing rate and the amount of the additive contained in the nonaqueous electrolyte to fall within respective specific ranges.

Examples of a method for controlling the amount of the additive contained in the nonaqueous electrolyte to be not less than 0.5 ppm and not more than 300 ppm include, but are not particularly limited to, a method in which the additive is dissolved in advance in the nonaqueous electrolyte (which is to be injected into a container that is to serve as a housing of the nonaqueous electrolyte secondary battery in a method for producing the nonaqueous electrolyte secondary battery (later described)) so that the amount of the additive becomes not less than 0.5 ppm and not more than 300 ppm.

[Method for Producing Nonaqueous Electrolyte Secondary Battery]

The nonaqueous electrolyte secondary battery in accordance with an embodiment of the present invention can be produced by a conventionally publicly known method. Examples of the conventionally publicly known method include a method in which (i) the positive electrode, the nonaqueous electrolyte secondary battery separator, and the negative electrode are disposed in this order to form a member for a nonaqueous electrolyte secondary battery (hereinafter referred to as a “nonaqueous electrolyte secondary battery member”), (ii) the nonaqueous electrolyte secondary battery member is placed in a container which is to serve as a housing of the nonaqueous electrolyte secondary battery, (iii) the container is filled with the nonaqueous electrolyte, and then (iv) the container is hermetically sealed while pressure inside the container is reduced.

### EXAMPLES

The present invention will be described below in more detail with reference to Examples and Comparative Examples. Note, however, that the present invention is not limited to such Examples.

[Measurement Methods]

The following method was used for measurement of physical properties and the like of a polyolefin porous film produced in each of Examples and Comparative Examples and measurement of a cycle characteristic of a nonaqueous electrolyte secondary battery produced in each of Examples and Comparative Examples.

### (1) Blocking Test

A blocking test was carried out by the following method in conformity to JIS K6404-14. Two test samples each of which had a size of 80 mm×80 mm were cut out from the polyolefin porous film such that sides of the test samples extend in parallel with the MD and the TD. Then, one of the two test samples was stacked on the other such that sides in the MD and the TD were aligned, then the two test samples in that state were sandwiched by two glass substrates each of which had a size of 100 mm×100 mm and a thickness of 3 mm, then the sandwiched two test samples were left to stand still under a load of 3.5 kg in an atmosphere at a temperature of 133° C.±1° C. for 30 minutes. Then, after the load was removed, the two test samples were cooled to a room temperature. After that, the test samples were cut out in a size of 27 mm×80 mm such that their longer sides extend in the MD, and a T-peel test was carried out at 100 mm/min with use of Autograph AGS-50NX manufactured by Shimadzu Corporation. Thus, a peeling strength was measured. A measured value of the peeling strength was an average value of peeling strength during a period from when the peeling strength became substantially constant after the start of peeling to when the peeling ends. Note that the same pair of test samples was subjected to measurements three times, and an average value was obtained from those measurements.

### (2) Puncture Strength

A maximum stress (gf) measured in a case where a polyolefin porous film was (i) fixed with use of a washer having a diameter of 12 mm and was then (ii) punctured with use of a pin at 200 mm/min was regarded as the puncture strength of the polyolefin porous film. The pin had a diameter of 1 mm and a tip having 0.5 R. Then, a ratio of change of a puncture strength measured in one polyolefin porous film after a blocking test with respect to a puncture strength measured in the one polyolefin porous film before the blocking test (=100×|(puncture strength after blocking test)−(puncture strength before blocking test)|/(puncture strength before blocking test)) was calculated.

### (3) Ionic Conductance Decreasing Rate (%)

LiPF₆ was dissolved in a mixed solvent of ethylene carbonate, ethyl methyl carbonate, and diethyl carbonate at a volume ratio of 3:5:2 so that a concentration of the LiPF₆ became 1 mol/L. Each of additives was added to and dissolved in the above obtained solution so that a concentration of the additive becomes 1.0% by weight, and then an ionic conductance (mS/cm) was measured. The ionic conductance was measured with use of an electric conductivity meter (ES-71) manufactured by HORIBA, Ltd.

The ionic conductance decreasing rate is represented by the following expression (A):

L=(LA−LB)/LA (A)

L: Ionic conductance decreasing rate (%)
LA: Ionic conductance (mS/cm) before addition of additive
LB: Ionic conductance (mS/cm) after addition of additive

### (4) Battery Characteristic of Nonaqueous Electrolyte Secondary Battery

Each of nonaqueous electrolyte secondary batteries assembled as described later was subjected to four cycles of initial charge and discharge at 25° C. Each of the four cycles of the initial charge and discharge was carried out at 25° C. and at a voltage ranging from 4.1 V to 2.7 V, and included CC-CV charge (where a terminal current condition was 0.02 C) at an electric current value of 0.2 C and CC discharge at a discharge electric current value of 0.2 C. Note that the value of an electric current at which a battery rated capacity defined as a one-hour rate discharge capacity was discharged in one hour was assumed to be 1 C. This applies also to the following descriptions.

Note here that the “CC-CV charge” is a charging method in which (i) a battery is charged at a predetermined constant electric current, (ii) after a certain voltage is reached, the certain voltage is maintained while the electric current is being reduced. Note also that the “CC discharge” is a discharging method in which a battery is discharged at a predetermined constant electric current until a certain voltage is reached (the same applies hereinafter).

The nonaqueous electrolyte secondary battery which has been subjected to the initial charge and discharge was subjected to a charge-discharge cycle carried out (i) with CC-CV charge at a charge current value of 1 C (where the terminal current condition was 0.02 C) and (ii) with CC discharge at discharge current values of 0.2 C, 1 C, 5 C, and 10 C in this order. Three charge-discharge cycles at 55° C. were carried out for each rate. In that case, the voltage range was 2.7 V to 4.2 V. In that case, a charging capacity was measured in charging at 1 C in the third cycle in measurement of a discharge rate characteristic at 10 C, and the charging capacity thus measured was employed as a charging capacity after high-rate discharge. Moreover, a ratio (%) of a charging capacity in measuring a high-rate characteristic was calculated with respect to a design capacity (20.5 mAh) of each of nonaqueous electrolyte secondary batteries produced in respective Examples and Comparative Examples. Hereinafter the ratio calculated as above described is referred to as “charging capacity maintenance rate”.

### Example 1

[Preparation of Nonaqueous Electrolyte Secondary Battery Separator]

70% by weight of ultra-high molecular weight polyethylene powder (GUR4032, manufactured by Ticona Corporation) and 30% by weight of polyethylene wax (FNP-0115, manufactured by Nippon Seiro Co., Ltd.) having a weight-average molecular weight of 1,000 were prepared. Assuming that a mixture of the ultra-high molecular weight polyethylene and the polyethylene wax had 100 parts by weight in total, 0.4 parts by weight of a phenol-based antioxidant 1, 0.1 parts by weight of a phosphorus-based antioxidant 2, and 1.3 parts by weight of sodium stearate were added to the mixture, and then calcium carbonate having an average particle size of 0.1 μm (manufactured by Maruo Calcium Co., Ltd.) was further added so as to account for 38% by volume of the entire volume of the resultant mixture. The resultant mixture in the form of powder was mixed with a Henschel mixer, and was then melted and kneaded in a twin screw kneading extruder. This produced a polyolefin resin composition. Then, the polyolefin resin composition was rolled into a sheet with use of a pair of rollers each having a surface temperature of 150° C. This sheet was immersed in an aqueous hydrochloric acid solution (containing 4 mol/L of hydrochloric acid and 0.5% by weight of nonionic surfactant) for removal of the calcium carbonate. Thus, a raw material polyolefin sheet was obtained. Subsequently, the raw material polyolefin sheet was stretched 6.2-fold at 105° C. with use of a tenter uniaxial stretching machine available from Ichikin Co., Ltd. while setting a temperature of a heat-fixing chamber to 120° C. Thus, a polyolefin porous film was obtained. The polyolefin porous film thus obtained was employed as a nonaqueous electrolyte secondary battery separator 1. Table 1 shows the physical properties of the nonaqueous electrolyte secondary battery separator 1 which were measured by the foregoing measuring method.

[Preparation of Nonaqueous Electrolyte Secondary Battery]

(Preparation of Positive Electrode)

A commercially available positive electrode was used which had been produced by applying LiNi_{0.5}Mn_{0.3}Co_{0.2}O₂, an electrically conductive agent, and PVDF (at a weight ratio of 92:5:3) to aluminum foil. The aluminum foil of the commercially available positive electrode was cut out as a positive electrode which had (i) a first portion on which a positive electrode active material layer was formed and which had a size of 40 mm×35 mm and (ii) a second portion on which no positive electrode active material layer was formed and which surrounded an outer periphery of the first portion with a width of 13 mm. The positive electrode active material layer had a thickness of 58 μm and a density of 2.50 g/cm³.

(Preparation of Negative Electrode)

A commercially available negative electrode was used which had been produced by applying graphite, a styrene-1,3-butadiene copolymer, and sodium carboxymethylcellulose (at a weight ratio of 98:1:1) to copper foil. The copper foil of the commercially available negative electrode was cut out as a negative electrode which had (i) a first portion on which a negative electrode active material layer was formed and which had a size of 50 mm×40 mm and (ii) a second portion on which no negative electrode active material layer was formed and which surrounded an outer periphery of the first portion with a width of 13 mm. The negative electrode active material layer had a thickness of 49 μm and a density of 1.40 g/cm³.

(Preparation of Nonaqueous Electrolyte)

LiPF₆ was dissolved in a mixed solvent, in which ethylene carbonate, ethyl methyl carbonate, and diethyl carbonate were mixed at a volume ratio of 3:5:2, so that a concentration of the LiPF₆ became 1 mol/L. A solution thus obtained was employed as an undiluted solution 1 of an electrolyte (aprotic polar solvent electrolyte containing Li⁺ ions).

Diethyl carbonate was added to 10.2 mg of pentaerythritol tetrakis[3-(3,5-di-tert-butyl-4-hydroxyphenyl)propionate] (having an ionic conductance decreasing rate of 4.0%) serving as an additive, and the additive was dissolved in the diethyl carbonate to obtain 5 mL of an additive solution 1. Then, 90 μL of the additive solution 1 and 1910 μL of the undiluted solution 1 of an electrolyte were mixed to obtain a nonaqueous electrolyte 1. An amount of the additive contained in the nonaqueous electrolyte 1 is indicated in Table 1.

(Assembly of Nonaqueous Electrolyte Secondary Battery)

A nonaqueous electrolyte secondary battery was prepared by the following method with use of the positive electrode, the negative electrode, the nonaqueous electrolyte secondary battery separator 1, and the nonaqueous electrolyte 1. The nonaqueous electrolyte secondary battery thus prepared was employed as a nonaqueous electrolyte secondary battery 1.

The positive electrode, the nonaqueous electrolyte secondary battery separator 1, and the negative electrode were disposed (arranged) in this order in a laminate pouch to obtain a nonaqueous electrolyte secondary battery member 1. In so doing, the positive electrode and the negative electrode were arranged so that a main surface of the positive electrode active material layer of the positive electrode was entirely included in a range of a main surface of the negative electrode active material layer of the negative electrode (i.e., entirely covered by the main surface of the negative electrode active material layer of the negative electrode).

Subsequently, the nonaqueous electrolyte secondary battery member 1 was put into a bag which had been formed in advance by disposing an aluminum layer on a heat seal layer. Further, 0.23 mL of the nonaqueous electrolyte 1 was put into the bag. The bag was then heat-sealed while pressure inside the bag was reduced, so that a nonaqueous electrolyte secondary battery 1 was prepared.

After that, a charging capacity after high-rate discharge of the nonaqueous electrolyte secondary battery 1 obtained by the above described method was measured, and thus a “charging capacity maintenance rate” was calculated. A result of the calculation is shown in Table 1.

### Example 2

[Preparation of Nonaqueous Electrolyte Secondary Battery]

(Preparation of Nonaqueous Electrolyte)

Diethyl carbonate was added to 10.3 mg of dibutylhydroxytoluene (having an ionic conductance decreasing rate of 5.3%) and the dibutylhydroxytoluene was dissolved in the diethyl carbonate to obtain 5 mL of an additive solution 2. Then, 90 μL of the additive solution 2 and 1910 μL of the undiluted solution 1 of an electrolyte were mixed to obtain a nonaqueous electrolyte 2. An amount of the additive contained in the nonaqueous electrolyte 2 is indicated in Table 1.

(Assembly of Nonaqueous Electrolyte Secondary Battery)

A nonaqueous electrolyte secondary battery was prepared as in Example 1, except that the nonaqueous electrolyte 2 was used instead of the nonaqueous electrolyte 1. The nonaqueous electrolyte secondary battery thus prepared was employed as a nonaqueous electrolyte secondary battery 2.

After that, a charging capacity after high-rate discharge of the nonaqueous electrolyte secondary battery 2 obtained by the above described method was measured, and thus a “charging capacity maintenance rate” was calculated. A result of the calculation is shown in Table 1.

### Example 3

[Preparation of Nonaqueous Electrolyte Secondary Battery]

(Preparation of Nonaqueous Electrolyte)

300 μL of the additive solution 1 and 1700 μL of the undiluted solution 1 of an electrolyte were mixed to obtain a nonaqueous electrolyte 3. An amount of the additive contained in the nonaqueous electrolyte 3 is indicated in Table 1.

(Assembly of Nonaqueous Electrolyte Secondary Battery)

A nonaqueous electrolyte secondary battery was prepared as in Example 1, except that the nonaqueous electrolyte 3 was used instead of the nonaqueous electrolyte 1. The nonaqueous electrolyte secondary battery thus prepared was employed as a nonaqueous electrolyte secondary battery 3.

After that, a charging capacity after high-rate discharge of the nonaqueous electrolyte secondary battery 3 obtained by the above described method was measured, and thus a “charging capacity maintenance rate” was calculated. A result of the calculation is shown in Table 1.

### Example 4

[Preparation of Nonaqueous Electrolyte Secondary Battery]

(Preparation of Nonaqueous Electrolyte)

Diethyl carbonate was added to 10.0 mg of vinylene carbonate (having an ionic conductance decreasing rate of: 1.3%) and the vinylene carbonate was dissolved in the diethyl carbonate to obtain 5 mL of an additive solution 3. 90 μL of the additive solution 3 and 1910 μL of the undiluted solution 1 of an electrolyte were mixed to obtain a nonaqueous electrolyte 4. An amount of the additive contained in the nonaqueous electrolyte 4 is indicated in Table 1.

(Assembly of Nonaqueous Electrolyte Secondary Battery)

A nonaqueous electrolyte secondary battery was prepared as in Example 1, except that the nonaqueous electrolyte 4 was used instead of the nonaqueous electrolyte 1. The nonaqueous electrolyte secondary battery thus prepared was employed as a nonaqueous electrolyte secondary battery 4.

After that, a charging capacity after high-rate discharge of the nonaqueous electrolyte secondary battery 4 obtained by the above described method was measured, and thus a “charging capacity maintenance rate” was calculated. A result of the calculation is shown in Table 1.

### Example 5

[Preparation of Nonaqueous Electrolyte Secondary Battery Separator]

A polyolefin porous film was obtained as in Example 1, except that 68% by weight of ultra-high molecular weight polyethylene powder (GUR2024, manufactured by Ticona Corporation) was prepared, an amount of the polyethylene wax (FNP-0115, manufactured by Nippon Seiro Co., Ltd.) having a weight-average molecular weight of 1,000 was set to 32% by weight, and the temperature of the heat-fixing chamber was set to 126° C. The polyolefin porous film thus obtained was employed as a nonaqueous electrolyte secondary battery separator 2. Table 1 shows the physical properties of the nonaqueous electrolyte secondary battery separator 2 which were measured by the foregoing measuring method.

[Preparation of Nonaqueous Electrolyte Secondary Battery]

(Assembly of Nonaqueous Electrolyte Secondary Battery)

A nonaqueous electrolyte secondary battery was prepared as in Example 1, except that the nonaqueous electrolyte secondary battery separator 2 was used instead of the nonaqueous electrolyte secondary battery separator 1. The nonaqueous electrolyte secondary battery thus prepared was employed as a nonaqueous electrolyte secondary battery 5.

After that, a charging capacity after high-rate discharge of the nonaqueous electrolyte secondary battery 5 obtained by the above described method was measured, and thus a “charging capacity maintenance rate” was calculated. A result of the calculation is shown in Table 1.

### Example 6

[Preparation of Nonaqueous Electrolyte Secondary Battery]

(Preparation of Nonaqueous Electrolyte)

200 μL of the additive solution 1 and 1800 μL of the undiluted solution 1 of an electrolyte were mixed, and further 900 μL of the undiluted solution 1 of an electrolyte was added to 100 μL of the mixed solution to obtain an additive solution 4. 50 μL of the additive solution 4 and 1950 μL of the undiluted solution 1 of an electrolyte were mixed to obtain a nonaqueous electrolyte 5. An amount of the additive contained in the nonaqueous electrolyte 5 is indicated in Table 1.

(Assembly of Nonaqueous Electrolyte Secondary Battery)

A nonaqueous electrolyte secondary battery was prepared as in Example 1, except that the nonaqueous electrolyte 5 was used instead of the nonaqueous electrolyte 1. The nonaqueous electrolyte secondary battery thus prepared was employed as a nonaqueous electrolyte secondary battery 6.

After that, a charging capacity after high-rate discharge of the nonaqueous electrolyte secondary battery 6 obtained by the above described method was measured, and thus a “charging capacity maintenance rate” was calculated. A result of the calculation is shown in Table 1.

### Example 7

[Preparation of Nonaqueous Electrolyte Secondary Battery]

(Preparation of Nonaqueous Electrolyte)

LiPF₆ was dissolved in a mixed solvent, in which ethylene carbonate and diethyl carbonate were mixed at a volume ratio of 3:7, so that a concentration of the LiPF₆ became 1 mol/L. A solution thus obtained was employed as an undiluted solution 2 of an electrolyte. Then, 90 μL of the additive solution 1 and 1910 μL of the undiluted solution 2 of an electrolyte were mixed to obtain a nonaqueous electrolyte 6. An amount of the additive contained in the nonaqueous electrolyte 6 is indicated in Table 1.

(Assembly of Nonaqueous Electrolyte Secondary Battery)

A nonaqueous electrolyte secondary battery was prepared as in Example 1, except that the nonaqueous electrolyte 6 was used instead of the nonaqueous electrolyte 1. The nonaqueous electrolyte secondary battery thus prepared was employed as a nonaqueous electrolyte secondary battery 7.

After that, a charging capacity after high-rate discharge of the nonaqueous electrolyte secondary battery 7 obtained by the above described method was measured, and thus a “charging capacity maintenance rate” was calculated. A result of the calculation is shown in Table 1.

### Example 8

[Preparation of Nonaqueous Electrolyte Secondary Battery]

(Preparation of Nonaqueous Electrolyte)

LiPF₆ was dissolved in a mixed solvent, in which ethylene carbonate, ethyl methyl carbonate, and diethyl carbonate were mixed at a volume ratio of 4:4:2, so that a concentration of the LiPF₆ became 1 mol/L. A solution thus obtained was employed as an undiluted solution 3 of an electrolyte. 90 μL of the additive solution 1 and 1910 μL of the undiluted solution 3 of an electrolyte were mixed to obtain a nonaqueous electrolyte 7. An amount of the additive contained in the nonaqueous electrolyte 7 is indicated in Table 1.

(Assembly of Nonaqueous Electrolyte Secondary Battery)

A nonaqueous electrolyte secondary battery was prepared as in Example 1, except that the nonaqueous electrolyte 7 was used instead of the nonaqueous electrolyte 1. The nonaqueous electrolyte secondary battery thus prepared was employed as a nonaqueous electrolyte secondary battery 8.

After that, a charging capacity after high-rate discharge of the nonaqueous electrolyte secondary battery 8 obtained by the above described method was measured, and thus a “charging capacity maintenance rate” was calculated. A result of the calculation is shown in Table 1.

### Example 9

[Preparation of Nonaqueous Electrolyte Secondary Battery]

(Preparation of Nonaqueous Electrolyte)

LiPF₆ was dissolved in a mixed solvent, in which ethylene carbonate, ethyl methyl carbonate, and diethyl carbonate were mixed at a volume ratio of 2:5:3, so that a concentration of the LiPF₆ became 1 mol/L. A solution thus obtained was employed as an undiluted solution 4 of an electrolyte. 90 μL of the additive solution 1 and 1910 μL of the undiluted solution 4 of an electrolyte were mixed to obtain a nonaqueous electrolyte 8. An amount of the additive contained in the nonaqueous electrolyte 8 is indicated in Table 1.

(Assembly of Nonaqueous Electrolyte Secondary Battery)

A nonaqueous electrolyte secondary battery was prepared as in Example 1, except that the nonaqueous electrolyte 8 was used instead of the nonaqueous electrolyte 1. The nonaqueous electrolyte secondary battery thus prepared was employed as a nonaqueous electrolyte secondary battery 9.

After that, a charging capacity after high-rate discharge of the nonaqueous electrolyte secondary battery 9 obtained by the above described method was measured, and thus a “charging capacity maintenance rate” was calculated. A result of the calculation is shown in Table 1.

### Comparative Example 1

[Preparation of Nonaqueous Electrolyte Secondary Battery]

(Preparation of Nonaqueous Electrolyte)

Diethyl carbonate was added to 10.8 mg of tris-(4-t-butyl-2,6-di-methyl-3-hydroxybenzyl)isocyanurate (having an ionic conductance decreasing rate of 6.1%) and the tris-(4-t-butyl-2,6-di-methyl-3-hydroxybenzyl)isocyanurate was dissolved in the diethyl carbonate to obtain 5 mL of an additive solution 5. 90 μL of the additive solution 5 and 1910 μL of the undiluted solution 1 of an electrolyte were mixed to obtain a nonaqueous electrolyte 9. An amount of the additive contained in the nonaqueous electrolyte 9 is indicated in Table 1.

(Assembly of Nonaqueous Electrolyte Secondary Battery)

A nonaqueous electrolyte secondary battery was prepared as in Example 1, except that the nonaqueous electrolyte 9 was used instead of the nonaqueous electrolyte 1. The nonaqueous electrolyte secondary battery thus prepared was employed as a nonaqueous electrolyte secondary battery 10.

After that, a charging capacity after high-rate discharge of the nonaqueous electrolyte secondary battery 10 obtained by the above described method was measured, and thus a “charging capacity maintenance rate” was calculated. A result of the calculation is shown in Table 1.

### Comparative Example 2

[Preparation of Nonaqueous Electrolyte Secondary Battery Separator]

A polyolefin porous film was obtained as in Example 1, except that a temperature of a heat-fixing chamber was set to 115° C. The polyolefin porous film thus obtained was employed as a nonaqueous electrolyte secondary battery separator 3. Table 1 shows the physical properties of the nonaqueous electrolyte secondary battery separator 3 which were measured by the foregoing measuring method.

[Preparation of Nonaqueous Electrolyte Secondary Battery]

(Assembly of Nonaqueous Electrolyte Secondary Battery)

A nonaqueous electrolyte secondary battery was prepared as in Example 1, except that the nonaqueous electrolyte secondary battery separator 3 was used instead of the nonaqueous electrolyte secondary battery separator 1. The nonaqueous electrolyte secondary battery thus prepared was employed as a nonaqueous electrolyte secondary battery 11.

After that, a charging capacity after high-rate discharge of the nonaqueous electrolyte secondary battery 11 obtained by the above described method was measured, and thus a “charging capacity maintenance rate” was calculated. A result of the calculation is shown in Table 1.

### Comparative Example 3

[Preparation of Nonaqueous Electrolyte Secondary Battery]

(Preparation of Nonaqueous Electrolyte)

400 μL of the additive solution 1 and 1600 μL of the undiluted solution 1 of an electrolyte were mixed to obtain a nonaqueous electrolyte 10. An amount of the additive contained in the nonaqueous electrolyte 10 is indicated in Table 1.

(Assembly of Nonaqueous Electrolyte Secondary Battery)

A nonaqueous electrolyte secondary battery was prepared as in Example 1, except that the nonaqueous electrolyte 10 was used instead of the nonaqueous electrolyte 1. The nonaqueous electrolyte secondary battery thus prepared was employed as a nonaqueous electrolyte secondary battery 12.

After that, a charging capacity after high-rate discharge of the nonaqueous electrolyte secondary battery 12 obtained by the above described method was measured, and thus a “charging capacity maintenance rate” was calculated. A result of the calculation is shown in Table 1.

### Comparative Example 4

[Preparation of Nonaqueous Electrolyte Secondary Battery]

(Assembly of Nonaqueous Electrolyte Secondary Battery)

A nonaqueous electrolyte secondary battery was prepared as in Example 1, except that the undiluted solution 1 of an electrolyte was used instead of the nonaqueous electrolyte 1. The nonaqueous electrolyte secondary battery thus prepared was employed as a nonaqueous electrolyte secondary battery 13.

After that, a charging capacity after high-rate discharge of the nonaqueous electrolyte secondary battery 13 obtained by the above described method was measured, and thus a “charging capacity maintenance rate” was calculated. A result of the calculation is shown in Table 1.

### CONCLUSION

TABLE 1

| | | | ADDITIVE IN | | NONAQUEOUS | |
|---|---|---|---|---|---|---|
| | POLYOLEFIN | | NONAQUEOUS | | ELECTROLYTE | |
| | POROUS FILM | | ELECTROLYTE | | SECONDARY BATTERY | |
| | | PUNCTURE | IONIC | | CHARGING | CHARGING |
| | | STRENGTH | CONDUCTANCE | | CAPACITY AFTER | CAPACITY |
| | PEELING | CHANGE | DECREASING | AMOUNT | HIGH-RATE | MAINTENANCE |
| | STRENGTH (N) | RATIO (%) | RATE (%) | (ppm) | DISCHARGE (mAh) | RATE (%) |
| EXAMPLE 1 | 0.20 | 12.4 | 4.0 | 90 | 16.93 | 82.6 |
| EXAMPLE 2 | 0.20 | 12.4 | 5.3 | 90 | 16.59 | 80.9 |
| EXAMPLE 3 | 0.20 | 12.4 | 4.0 | 300 | 16.82 | 82.0 |
| EXAMPLE 4 | 0.20 | 12.4 | 1.3 | 90 | 16.60 | 81.0 |
| EXAMPLE 5 | 0.38 | 4.1 | 4.0 | 90 | 16.09 | 78.5 |
| EXAMPLE 6 | 0.20 | 12.4 | 4.0 | 0.5 | 16.90 | 82.4 |
| EXAMPLE 7 | 0.20 | 12.4 | 4.0 | 90 | 16.86 | 82.2 |
| EXAMPLE 8 | 0.20 | 12.4 | 4.0 | 90 | 16.60 | 81.0 |
| EXAMPLE 9 | 0.20 | 12.4 | 4.0 | 90 | 16.94 | 82.6 |
| COM. EX. 1 | 0.20 | 12.4 | 6.1 | 90 | 13.76 | 67.1 |
| COM. EX. 2 | 0.16 | 18.4 | 4.0 | 90 | 14.74 | 71.9 |
| COM. EX. 3 | 0.20 | 12.4 | 4.0 | 400 | 14.56 | 71.0 |
| COM. EX. 4 | 0.20 | 12.4 | — | — | 13.04 | 63.6 |

Each of the nonaqueous electrolyte secondary batteries prepared in Examples 1 through 9 includes (i) a nonaqueous electrolyte secondary battery separator that includes a polyolefin porous film having the peeling strength of not less than 0.2 N and the puncture strength change ratio of not more than 15% and (ii) a nonaqueous electrolyte containing an additive in an amount of not less than 0.5 ppm and not more than 300 ppm, the additive having an ionic conductance decreasing rate of not less than 1.0% and not more than 6.0%, the ionic conductance decreasing rate being an ionic conductance decreasing rate of the reference electrolyte and being obtained when the additive is dissolved in the reference electrolyte so that a concentration of the additive becomes 1.0% by weight. According to the nonaqueous electrolyte secondary batteries prepared in Comparative Examples 1 through 4, any one of the peeling strength, the puncture strength change ratio, the ionic conductance decreasing rate, and the amount of the additive is outside the above-described range. As is clear from the results indicated in Table 1, the nonaqueous electrolyte secondary batteries prepared in Examples 1 through 9 had higher charging capacity maintenance rates after high-rate discharge as compared with the nonaqueous electrolyte secondary batteries prepared in Comparative Examples 1 through 4, and it was found that a deterioration in charging capacity after high-rate discharge was inhibited in the nonaqueous electrolyte secondary batteries prepared in Examples 1 through 9 as compared with the nonaqueous electrolyte secondary batteries prepared in Comparative Examples 1 through 4.

### INDUSTRIAL APPLICABILITY

In the nonaqueous electrolyte secondary battery in accordance with an embodiment of the present invention, a deterioration in charging capacity after high-rate discharge is inhibited. Therefore, the nonaqueous electrolyte secondary battery in accordance with an embodiment of the present invention can be suitably used for various purposes, in particular, as batteries (e.g., batteries for consumer appliances such as power tools and cleaners, and on-vehicle batteries) which are expected to carry out high-rate discharge.

1. A nonaqueous electrolyte secondary battery comprising:
a nonaqueous electrolyte secondary battery separator including a polyolefin porous film; and
a nonaqueous electrolyte,
the polyolefin porous film having a peeling strength of not less than 0.2 N, the peeling strength being measured by a blocking test,
the polyolefin porous film having a puncture strength that changes through the blocking test by not more than 15%, and
the nonaqueous electrolyte containing an additive in an amount of not less than 0.5 ppm and not more than 300 ppm, the additive having an ionic conductance decreasing rate L of not less than 1.0% and not more than 6.0%, the ionic conductance decreasing rate L being represented by the following expression (A):
L=(LA−LB)/LA (A)
where: LA represents an ionic conductance (mS/cm) of a reference electrolyte obtained by dissolving LiPF₆ in a mixed solvent, containing ethylene carbonate, ethyl methyl carbonate, and diethyl carbonate at a volume ratio of 3:5:2, so that a concentration of the LiPF₆ becomes 1 mol/L;
LB represents an ionic conductance (mS/cm) of an electrolyte obtained by dissolving the additive in the reference electrolyte so that a concentration of the additive becomes 1.0% by weight; and
the blocking test is carried out by (i) sandwiching, by a jig having a size of 100 mm×100 mm, two polyolefin porous films each of which is said polyolefin porous film and has a size of 80 mm×80 mm, (ii) leaving the two polyolefin porous films to stand still under a load of 3.5 kg in an atmosphere at a temperature of 133° C.±1° C. for 30 minutes, (iii) then removing the load, (iv) cooling the two polyolefin porous films to a room temperature, (v) then cutting out a specimen having a size of 27 mm×80 mm from the two polyolefin porous films, and (vi) measuring a peeling strength of the specimen at 100 mm/min.

2. The nonaqueous electrolyte secondary battery as set forth in claim 1, wherein:
the nonaqueous electrolyte secondary battery separator is a laminated separator in which a porous layer is disposed on one surface or both surfaces of the polyolefin porous film; and
the porous layer contains one or more resins selected from the group consisting of a polyolefin, a (meth)acrylate-based resin, a polyamide-based resin, a polyester-based resin, and a water-soluble polymer.

3. The nonaqueous electrolyte secondary battery as set forth in claim 2, wherein the polyamide-based resin is an aramid resin.
